(19) United States
(12) Patent Application Publication
(10) Pub. No.: US 2011/0310199 A1
(43) Pub. Date: Dec. 22, 2011

(54) INK CARTRIDGE, IMAGE RECORDING APPARATUS, AND IMAGE RECORDING APPARATUS PACKAGED BODY

(75) Inventors: Tomohiro KANBE, Nagoya-shi (JP); Hirotake NAKAMURA, Nagoya-shi (JP); Naoya OKAZAKI, Gifu-ken (JP)

(73) Assignee: Brother Kogyo Kabushiki Kaisha, Nagoya-shi (JP)

(21) Appl. No.: 13/163,190

(22) Filed: Jun. 17, 2011

(30) Foreign Application Priority Data
Jun. 17, 2010 (JP) 2010-137807

(51) Int. Cl. B41J 2/175

(52) U.S. Cl. 347/86

(57) ABSTRACT

A print liquid cartridge comprises an ink chamber, a liquid supply portion, and a translucent portion. The ink chamber which accumulates ink therein is positioned between a front side in an insertion direction and a rear side in an opposite direction to the insertion direction. The liquid supply portion which supplies ink stored in the ink chamber to an exterior of the ink chamber is positioned at the front side. The translucent portion which is in fluid communication with an interior of the ink chamber is positioned at the front side. A light-transmitting state of the translucent portion changes in response to a change in the amount of the ink accumulated in the ink chamber. The ink supply portion projects farther forward from the rear side than the translucent portion.

### CROSS REFERENCE TO RELATED APPLICATION

This application claims priority from Japanese Patent Application No. 2010-137807, filed Jun. 17, 2010. The entire content of the priority application is incorporated herein by reference.

### BACKGROUND OF THE INVENTION

1. Technical Field

The present invention relates to image recording apparatus having a cartridge mounting portion installable in and removable therefrom and image recording apparatus packaged body, such that each image recording apparatus is packaged in a box.

2. Description of Related Art

A known image recording apparatus of a so-called tube-supply system has an ink cartridge that is positioned on the outside of a carriage on which a recording head is mounted, and the ink cartridge and the recording head are connected via a tube. The ink cartridge is configured to insert horizontally into an opening of a cartridge mounting portion positioned in the front of the image recording apparatus. The cartridge may be inserted into and removed from the cartridge mounting portion. When the ink cartridge is inserted into the cartridge mounting portion, an ink channel extending from the ink cartridge to the recording head is formed.

The cartridge mounting portion may include a hollow needle or the like, which is referred to as an “ink needle,” such that the ink stored in the ink cartridge is supplied to the recording head via the tube.

The cartridge mounting portion may include a sensor configured to detect the amount of ink stored in the ink cartridge. The cartridge mounting portion may also include a sensor configured to detect whether the ink cartridge is installed.

When the sensors, substrates, or the like are positioned at or adjacent to the ink supply portion of the ink cartridge or the ink needle, ink may leak from the ink supply portion or the ink needle and adhere to the sensors or the substrates Ink may spill freely into the machine, degrading the sensors or the substrates. In this manner, an arrangement of the sensors and the substrates in the cartridge mounting portion is constrained by an arrangement of the ink supply portion and the ink needle.

### SUMMARY OF THE INVENTION

In view of these and other shortcomings of the related art, it is an object of the invention to provide a means to avoid ink leakage and to prevent the ink from adhering to a sensor or a substrate even when a position of installation of a cartridge is changed.

According to an aspect of the invention, there is provided a print liquid cartridge comprising an ink chamber, a liquid supply portion, and a translucent portion. The ink chamber may be positioned between a front side located in an insertion direction and a rear side located in a direction opposite the insertion direction. The ink chamber may accumulate ink therein. The ink supply portion may be positioned at the front side for supplying ink and may supply ink stored in the ink chamber to an exterior of the ink chamber. The translucent portion may be positioned at the front side and may be in fluid communication with an interior of the ink chamber. A light-transmitting state of the translucent portion may change in response to a change in the amount of the ink accumulated in the ink chamber. The ink supply portion may extend in the insertion direction farther than the translucent portion extends in the insertion direction.

According to another aspect of the invention, there is provided a cartridge mounting portion. The cartridge mounting portion is configured to receive therein a print liquid cartridge when the print liquid cartridge is inserted into the cartridge mounting portion in the insertion direction. The cartridge mounting portion comprises a liquid supply needle, a first sensor, a second sensor, and a third sensor. The liquid supply needle may extend along the insertion direction and may be inserted into a liquid supply portion. The first sensor may output first detection information based on detection of the first projecting portion. The second sensor may output second detection information based on detection of the second detection portion. The third sensor may output third detection information based on detection of the signal blocking portion, which is based on the light-transmitting state of the translucent portion; and the third sensor may output fourth detection information based on the light-transmitting state of the translucent portion.

Other objects, features, and advantages will be apparent to persons of ordinary skill in the art from the following detailed description of the invention and the accompanying drawings.

### BRIEF DESCRIPTION OF THE DRAWINGS

For a more complete understanding of the present invention, needs satisfied thereby, and the objects, features, and advantages thereof, reference now is made to the following description taken in connection with the accompanying drawings.

FIG. 1 is a perspective view of an image recording apparatus according to an embodiment of the invention;

FIG. 2 is a diagrammatic cross-sectional view of an internal structure of the image recording apparatus of FIG. 1;

FIG. 3 is a perspective view of an ink cartridge;

FIG. 4 is a vertical cross-sectional view of the internal configuration of the ink cartridge of FIG. 3;

FIG. 5 is a perspective view of a cartridge mounting portion;

FIG. 6 is a vertical cross-sectional view of the ink cartridge of FIG. 3 mounted on the cartridge mounting portion of FIG. 5;

FIG. 7 is a diagrammatic cross-sectional view of an ink cartridge mounted on a cartridge mounting portion;

FIG. 8A is a diagrammatic perspective view of an image recording apparatus where a protrusion is positioned on a front surface;

FIG. 8B is a diagrammatic perspective view of an image recording apparatus where a front surface is curved;

FIG. 9 is a side view of an image recording apparatus installed with a rear surface as a bottom surface; and

FIG. 10 is a perspective view of an image recording apparatus packaged in a box-shaped material.

### DESCRIPTION OF THE EMBODIMENTS

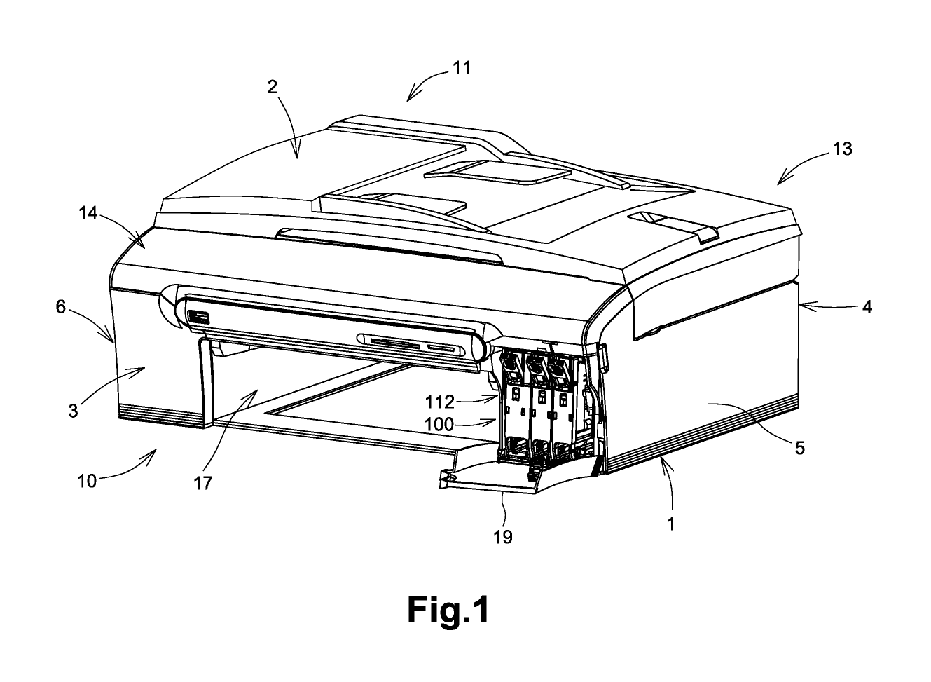

Embodiments of the present invention, and their features and advantages, may be understood by referring to FIGS. 1-10, like numerals being used for like corresponding parts in the various drawings. The embodiments described below are examples only, and the embodiments may be modified as needed without changing the scope of the invention.

FIG. 1 is a perspective view depicting an image recording apparatus 10 having an ink supply device 100. The terms “upward,” “downward,” “upper,” “lower,” “above,” “below,” “beneath,” “right,” “left,” “front,” “rear,” and the like will be used throughout the description assuming that the image recording apparatus 10 is positioned in an orientation in which it is intended to be used. The image recording apparatus 10 corresponds to an image recording apparatus. A scanner unit 13 is positioned on or above the image recording apparatus 10. The scanner unit 13 may be a scanner comprising, e.g., a flat bed scanner and an auto document feeder 11.

The outside shape of the image recording apparatus 10 is a rectangular shape with a larger width and depth than height. The image recording apparatus 10 has a housing 14. The housing 14 may have a rectangular shape comprising six surfaces: a lower surface 1, an upper surface 2, a front surface 3, a rear surface 4, a right side surface 5, and a left side surface 6.

The lower surface 1 is a surface corresponding to the bottom in the height direction when the image recording apparatus 10 is installed in a packaged state (the state depicted in FIG. 1). The upper surface 2 is a surface opposing the lower surface 1 at a distance in the height direction. The scanner unit 13 may be positioned at upper surface 2. The front surface 3 extends upright from the lower surface 1, connects the lower surface 1 and the upper surface 2 on the front side of the device, and may be formed with two openings 17 and 112. The rear surface 4 extends upright from the lower surface 1, and connects the lower surface 1 and the upper surface 2 opposite to the front surface 3 at a distance. The right side surface 5 extends upright from the lower surface 1, and connects the lower surface 1, the upper surface 2, the front surface 3, and the rear surface 4 on the right side when viewing the image recording apparatus 10 from the front side of the device. The left side surface 6 extends upright from the lower surface 1, and connects the lower surface 1, the upper surface 2, the front surface 3, and the rear surface 4 on the left side when viewing the image recording apparatus 10 from the front side of the device. The lower surface 1 corresponds to a bottom surface, the front surface 3 corresponds to a first surface, and the rear surface 4 corresponds to a second surface.

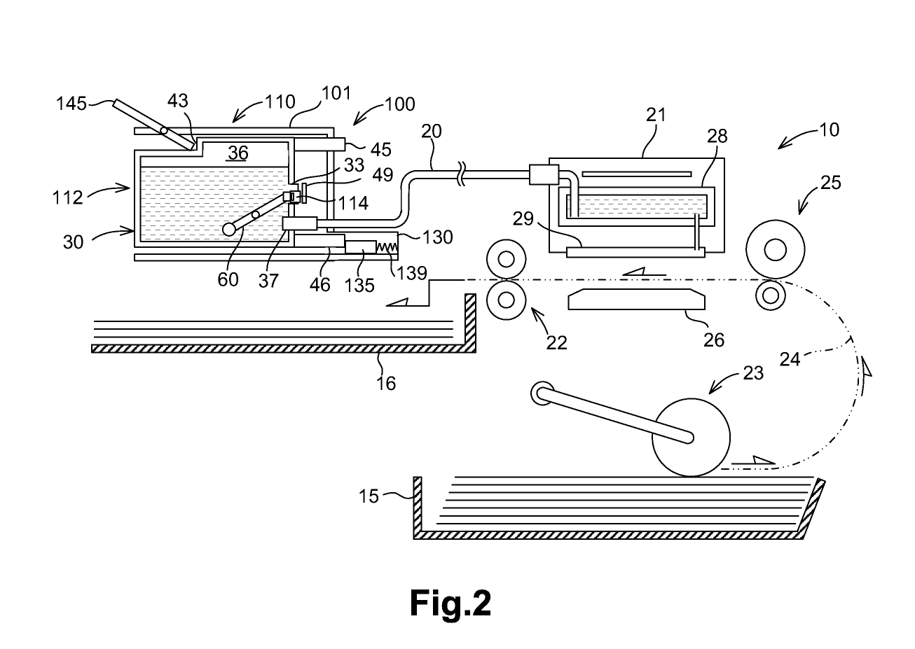

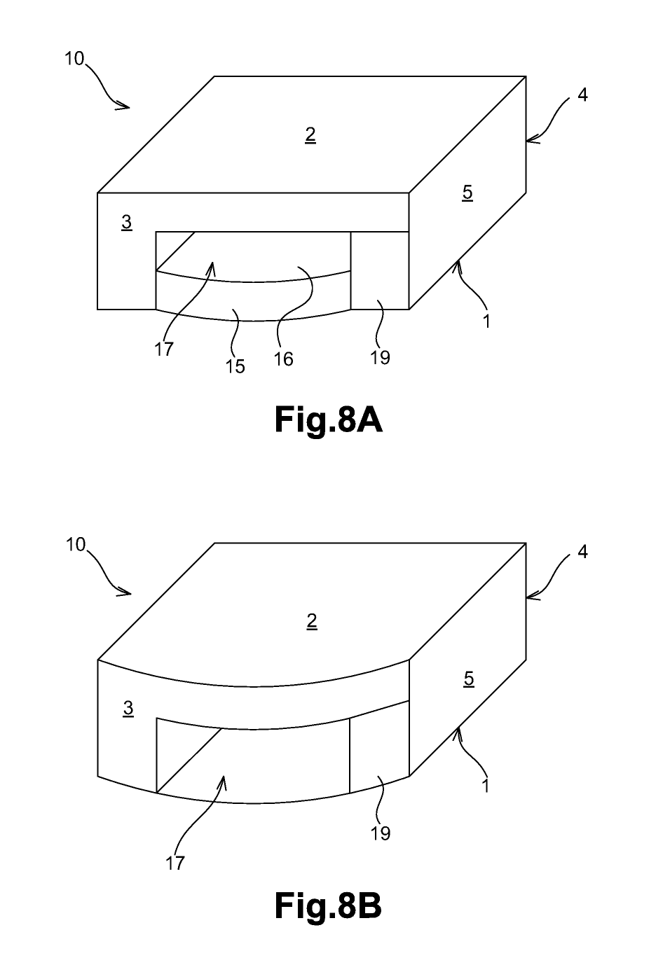

A paper feed tray 15 and a paper discharge tray 16 (see FIG. 2) may be mounted on the image recording apparatus 10 via the opening 17. The paper feed tray 15 may be configured to accommodate printing papers of various sizes, such as: A4 size, B5 size, etc. The paper discharge tray 16 may be supported by the paper feed tray 15 and may be arranged above the paper feed tray 15. FIG. 1 depicts the image recording apparatus 10 in a state with the paper feed tray 15 and the paper discharge tray 16 removed. FIG. 8A depicts the image recording apparatus 10 in a state with the paper feed tray 15 and the paper discharge tray 16 mounted on the image recording apparatus 10. As depicted in FIG. 8A, the paper feed tray 15 and the paper discharge tray 16 may project from the front surface 3 in a direction away from the rear surface 4 when mounted on the image recording apparatus 10. Portions of the paper feed tray 15 and the paper discharge tray 16 projecting from the image recording apparatus 10 in the state of being mounted on the image recording apparatus 10 correspond to protrusions.

The housing 14 may have a door 19 on the right side of the front surface of the device. The door 19 may be configured to open and close with respect to the housing 14. When the door 19 opens, a user may access the interior of the device through the opening 112. The opening 112 allows access to the ink supply device 100 positioned within the interior of the device. In other words, an ink cartridge 30 may be removed and replaced through the opening 112.

As depicted in FIG. 2, the image recording apparatus 10 may be configured to print an image by selectively ejecting ink drops onto a printing paper. The ink supply device 100 may comprise a cartridge mounting portion 110. The cartridge mounting portion 110 allows the ink cartridge 30 to be mounted therein. The cartridge mounting portion 110 includes the opening 112 which opens toward the outside on one surface of the image recording apparatus 10. The ink cartridge 30 may be configured to be inserted into the cartridge mounting portion 110 and removed from the cartridge mounting portion 110 through the opening 112.

Ink is stored in the ink cartridge 30. A recording head 21 may connect to the ink cartridge 30 via an ink tube 20 when the cartridge 30 is mounted in the cartridge mounting portion 110. The recording head 21 may have a sub tank 28 in which temporarily stores the ink supplied through the ink tube 20. The recording head 21 may include a plurality of nozzles 29 through which ink supplied from the sub tank 28 may selectively eject to form a recording image.

The image recording apparatus 10 may comprise a paper feed tray 15, a sheet supply roller 23, a sheet passage 24, a pair of transfer rollers 25, a platen 26, a pair of discharge rollers 22, and a paper discharge tray 16 arranged in this order along a sheet feeding direction. The sheet supply roller 23 may supply the sheet from the paper feed tray 15 to the sheet passage 24; and the pair of transfer rollers 25 may further convey the sheet to the platen 26. Then, the recording head 21 may selectively eject the ink onto the sheet passing through the platen 26 to form an image on the sheet. The pair of discharge rollers 22 then may discharge the sheet onto the discharge tray 16.

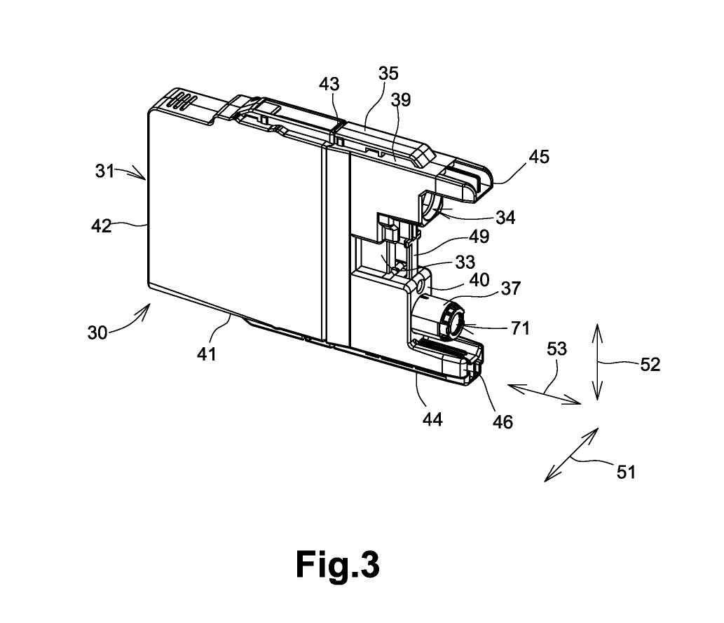

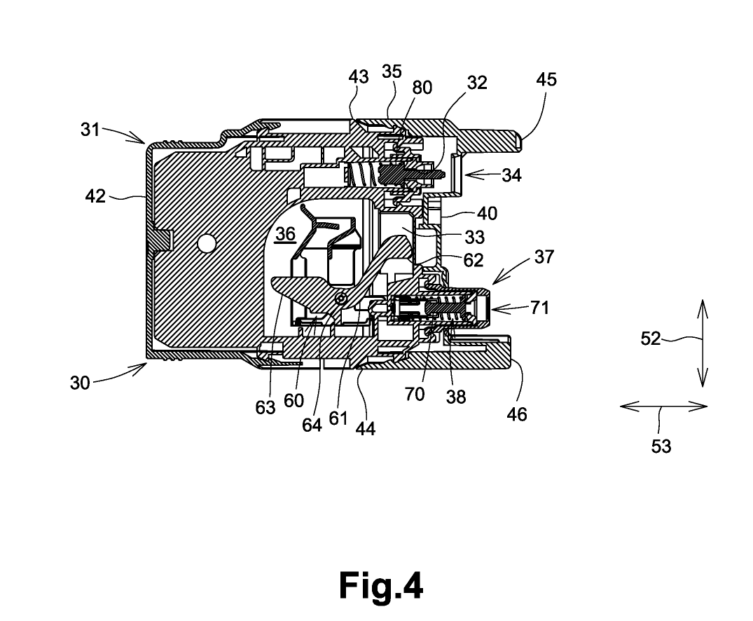

Next, the ink cartridge 30 will be described. As depicted in FIGS. 3 and 4, the ink cartridge 30 may define therein an ink chamber 36 which stores a print liquid, e.g., toner, ink, etc. The ink cartridge 30 may comprise a cartridge body 31 that defines an outer perimeter of the ink cartridge 30. The inside of the cartridge body 31 may define the ink chamber 36, or a member separate from the cartridge body 31, but inside the cartridge body 31, may define the ink chamber 36.

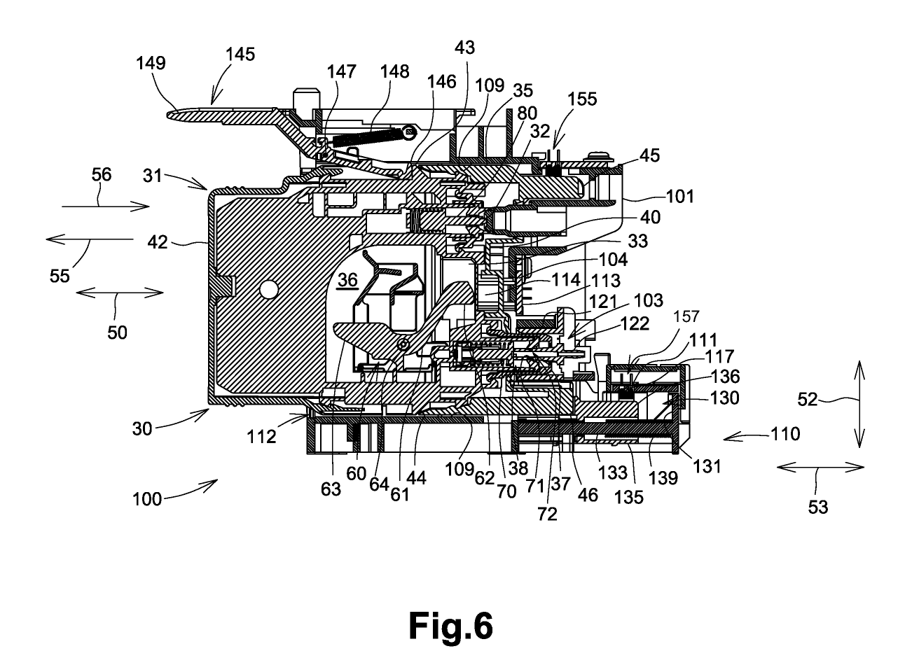

The ink cartridge 30 may be configured to be inserted into and removed from the cartridge mounting portion 110 in an upright position depicted in FIGS. 3 and 4, i.e. along a direction indicated by an arrow 50 (see FIG. 6) with a lower surface in the drawing as a bottom surface and an upper surface in the drawing as an upper surface (hereinafter, referred to as an “insertion and removal directions 50”). In other words, the ink cartridge 30 may be inserted into the cartridge mounting portion 110 along the insertion and removal directions 50, and may be removed from the cartridge mounting portion 110 along the insertion and removal directions 50. The ink cartridge 30 may be configured to be inserted into or removed from the cartridge mounting portion 110 in the upright position. The ink cartridge 30 is inserted into the cartridge mounting portion 110 in an insertion direction 56 (see FIG. 6), and the ink cartridge 30 is removed from the cartridge mounting portion 110 in a removal direction 55 (see FIG. 6). A height direction 52 corresponds to the gravity direction (see FIGS. 3, 4, and 6).

The cartridge body 31 may have a generally flat, rectangular shape with a width in a direction indicated by an arrow 51 (hereinafter, referred to as a width direction or a horizontal direction), a height in a direction indicated by an arrow 52 that is perpendicular to the width direction (hereinafter, referred to as a vertical direction or a height direction), and a depth in a direction indicated by an arrow 53 that is perpendicular to the vertical direction and the width direction (hereinafter, referred to as a depth direction). The height of cartridge body 31 and the depth of cartridge body 31 are each greater than the width of cartridge body 31. A front wall 40 of the cartridge body 31 is positioned on the front side of the image forming apparatus 10 when the ink cartridge 30 is inserted into the cartridge mounting portion 110, and a rear wall 42 of the cartridge body 31 is positioned on the rear side of the cartridge body 31. The front wall 40 and the rear wall 42 may be positioned opposite to each other in the insertion and removal directions 50. Four walls may separate the front wall 40 from the rear wall 42: a pair of side walls (not depicted) extending in the insertion and removal directions 50, an upper wall 39 connecting the upper edges of the side walls, and a lower wall 41 also connecting the lower edges of the side walls. The upper wall 39 extends from an upper edge of the front wall 40 to an upper edge of the rear wall 42; and the lower wall extends from a lower edge of the front wall 40 to a lower edge of the rear wall 42. The insertion and removal directions 50 are parallel to the depth direction 53.

A translucent portion 33 may protrude frontward from the front wall 40 in the depth direction 53 at about an intermediate position along front wall 40 in the vertical direction 52. Further, a first projection 46 may protrude frontward from a lower end portion of the front wall 40 in the depth direction 53. The first projection 46 may protrude frontward farther in the depth direction 53 than the translucent portion 33. That is, a protruding length of the translucent portion 33 may be less than a protruding length of the first projection 46. The translucent portion 33 may have a box shape with an opening for allowing the translucent portion 33 to be in fluid communication with an interior of the ink chamber 36. Further, the translucent portion 33 may have a pair of side walls (left and right walls, not depicted) made from a translucent resin material and connected to the front wall 40. The side walls may allow light emitted from a first optical sensor 114 (see FIG. 4) to pass therethrough. Each side wall may extend in the vertical direction 52 or may deviate relative to the vertical direction 52. The first optical sensor 114 may be positioned at the cartridge installation portion 110.

As depicted in FIG. 4, the translucent portion 33 may define a hollow box space. A sensor arm 60 may be movably positioned within the ink chamber 36. The sensor arm 60 may comprise an arm body 61 and a shaft 64. The arm body 61 may be plate shaped, and may be pivotally supported by the shaft 64. The shaft 64 may extend in the width direction 51, and a wall (not depicted) extending from the interior of the ink cartridge 30 may support the shaft 64. The arm body 61 may comprise an indicator 62 and a float 63, respectively positioned at opposite ends of the arm body 61. The indicator 62 may be movably positioned in the hollow box space of the translucent portion 33, i.e., between the pair of left and right walls of the translucent portion 33 in the widthwise direction 51. With this structure, the sensor arm 60 may be configured to shift its pivoting posture in accordance with an amount of the ink in the ink chamber 36 between a lower position, in which the indicator 62 approaches a lower wall of the translucent portion 33, and an upper position, in which the indicator 62 approaches an upper wall of the translucent portion 33.

When the ink cartridge 30 is inserted into the cartridge mounting portion 110, the translucent portion 33 may be configured to be changeable between a light-transmissive state and a non-light-transmissive state. In the light-transmissive state, at least a predetermined amount of infrared light may be transmitted through the translucent portion 33, and in the non-light-transmissive state, less than the predetermined amount of infrared light is transmitted therethrough (e.g., the light may be blocked, deflected, or attenuated, or the light may be shut off, attenuated by a prism or reflected by a mirror to alter a path of the light). Specifically, the light-transmissive state exists when the indicator 62 is at its upper position, and non-light-transmissive state exists when the indicator 62 is at its lower position. The image recording apparatus 10 may detect whether the amount of ink in the ink chamber 36 is less than a predetermined amount of ink based on a light transmission state of the translucent portion 33, i.e., the light-transmissive state or the non-light-transmissive state.

As described later, the first optical sensor 114 may comprise a light emitting element 118 and a light receiving element 119 opposite each other in the width direction 51. The light receiving element 119 may receive light emitted from the light-emitting element 118. The sensor arm 60 may not be positioned within the translucent portion 33. The interior of the translucent portion 33 may be in fluid communication with the interior of the ink chamber 36, as described above. Therefore, if ink is in the translucent portion 33, the ink may block, deflect, or attenuate infrared light emitted from the light emitting element 118; and, if ink is absent or insufficient in the translucent portion 33, infrared light transmits through the translucent portion 33. Alternatively, if ink is in the translucent portion 33, the infrared light emitted from the light emitting element 118 may be reflected to avoid incidence with the light receiving element 119; and, if ink is absent or insufficient in the translucent portion 33, the infrared light emitted from the light emitting element 118 may reflect to strike the light receiving element 119.

As depicted in FIG. 4, an opening 34 may be formed on the front wall 40 of the cartridge body 31 on an upper side of the translucent portion 33 so as to penetrate through the front wall 40 in the depth direction 53, and an air communication port 32 may be formed on the rear wall side of the opening 34 in the insertion and removal directions 50. The air communication port 32 may be a through hole penetrating through a wall which defines the ink chamber 36 in the depth direction 53. The air communication port 32 may be sealed with a film (not depicted) in an unused state before initially inserting the ink cartridge 30 into the cartridge mounting portion 110, e.g., prior to shipment. Upon initially installing the ink cartridge 30 into the cartridge installation portion 110, a rod 124 positioned at the cartridge mounting portion 110 may break the sealing film to open the air communication port, so that the ink chamber 36 reaches atmospheric pressure.

The air communication port 32 may be opened and closed using a valve 80. Specifically, when valve 80 is open, air communication port 32 may communicate with an external atmosphere; and when valve 80 is closed, air communication port 32 may not communicate with the external atmosphere. Upon opening the valve 80, negative pressure in the ink chamber 36 reaches the atmospheric pressure. Incidentally, the air communication port 32 may be positioned at a position other than the front wall 40 as long as the interior of the ink chamber 36 may communicate with the external atmosphere. In first, if the air communication port 32 is positioned lower than the translucent portion 33 or positioned at the rear wall 42, adhesion of ink to a circuit substrate of the first optical sensor 114 may be avoided. Further, the air communication passage 32 is not necessarily required to be inside of the ink cartridge 30, e.g., ink chamber 36 is used while maintaining negative pressure.

As depicted in FIG. 4, an ink supply unit 37 may be positioned on a front side of the ink cartridge 30, e.g., the front wall 40 of the cartridge body 31 at a position below the translucent portion 33. The ink supply unit 37 may have a cylindrical outer shape, and ink supply unit 37 may project frontward from the front wall 40 in the insertion direction 56. The ink supply unit 37 may be formed with an ink supply portion 71 at or adjacent to a projecting end thereof. An ink flow channel 38 may be formed to extend from the ink supply portion 71 through an internal space of the ink supply unit 37 to the ink chamber 36 in the insertion and removal directions 50. The ink supply portion 71 may be configured to be opened or closed by an ink supply valve 70. When the ink cartridge 30 is inserted into the cartridge mounting portion 110, an ink needle 122 (see FIG. 6) positioned on the cartridge mounting portion 110 may insert into the ink supply portion 71 and may open the ink supply valve 70. Thereby, ink may flow out from the ink chamber 36 through the ink flow channel 38 to the ink needle 122 positioned on the cartridge mounting portion 110.

The ink supply portion 71 may extend farther frontward in insertion direction 56 than the translucent portion 33.

The ink supply portion 71 is not limited to a configuration in which the ink supply valve 70 opens and closes the ink supply portion 71. For example, a configuration in which a film or the like closes the ink supply portion 71, and the ink needle 122 breaks the film to open the ink supply portion 71 when the ink cartridge 30 is inserted into the cartridge mounting portion 110 is also applicable.

A retaining portion 43 may be formed on the upper wall 39 of the cartridge body 31 near the center of the upper wall 39 in the depth direction 53. The retaining portion 43 may be a projection having a surface extending in the width direction 51 and the height direction 52 of the ink cartridge 30 and having a wedge shape. A lock lever 145, described below, may be configured to retain the retaining portion 43 when the ink cartridge 30 is inserted into the cartridge mounting portion 110. The retaining portion 43 may be configured to receive an urging force to push the ink cartridge 30 outward in the removal direction 55.

The cartridge body 31 may comprise the first projection 46 and a second projection 45. The first projection 46 may be positioned at or adjacent to the lower end of the front wall 40 of the cartridge body 31. Therefore, the first projection 46 may be arranged below the ink supply unit 37. The width of the first projection 46 may be the same as the width of the front wall 40. The first projection 46 may project from the front wall 40 in the insertion direction 56. A distal end of the first projection 46 may project up to the front side of the ink supply portion 71, which is the distal end of the ink supply unit 37, in the insertion direction 56.

The second projection 45 may be positioned at or adjacent to the upper end of the front wall 40 of the cartridge body 31 so as to extend from the front wall 40 along the insertion direction 56. The width of the second projection 45 may be the same as the width of the front wall 40. The second projection 45 may project from the front wall 40 in the insertion direction 56. A distal end of the second projection 45 may project up to the front side of the ink supply portion 71, which is a distal end of the ink supply unit 37, in the insertion direction 56. The second projection 45 may have the same width as the front wall 40, but may be a plate-shaped member having a narrower width than the width of the front wall 40.

The first projection 46 and the second projection 45 may both project in the insertion direction 56 away from the translucent portion 33. In other words, in the ink cartridge 30, the first projection 46 and the second projection 45 may be arranged on the front side of the terminal end wall 104 in the insertion direction 56, and the translucent portion 33 may be arranged on the rear side of the terminal end wall 104 in the insertion direction 56. The translucent portion 33 and the ink supply portion 71 may both be arranged between the first projection 46 and the second projection 45 in the height direction 52.

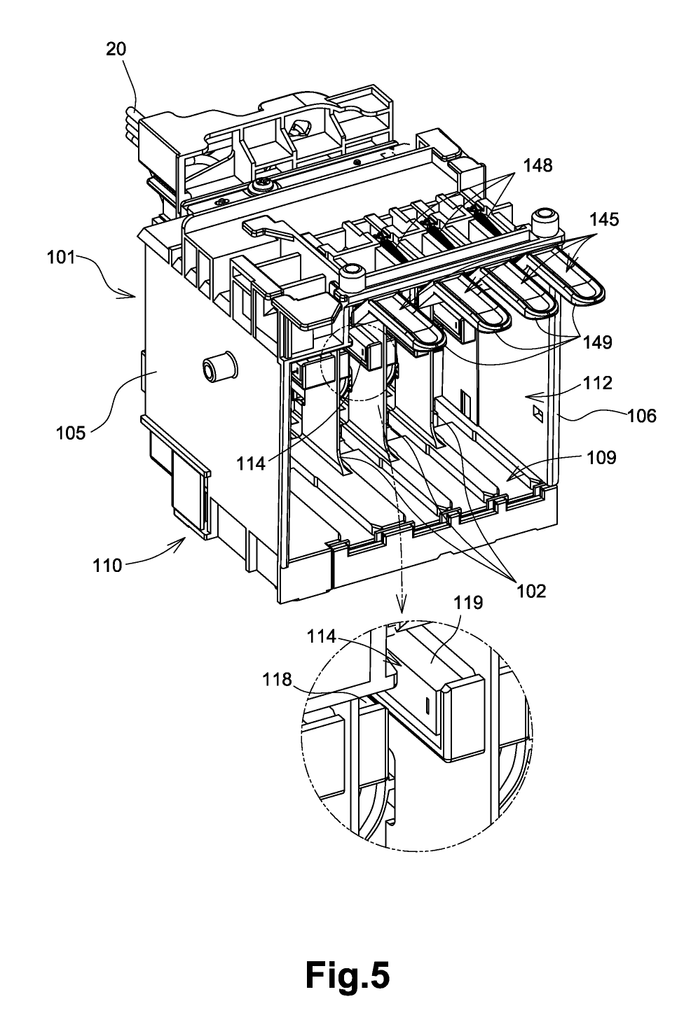

A signal blocking portion 49 that may be configured to attenuate or block infrared light passing in the width direction 51 is positioned at or adjacent to the front wall 40 of the cartridge body 31 between the first projection 46 and the second projection 45 in the height direction 52, at the front side of the translucent portion 33 in the insertion direction 56, and at the back side of the ink supply portion 71 in the insertion direction 56. The signal blocking portion 49 may have substantially the same width as the translucent portion 33 in the width direction 51. The width of the signal blocking portion 49 may be sized such that the signal blocking portion 49 and the translucent portion 33 may insert between the light-emitting element 118 and the light-receiving element 119 of the first optical sensor 114 (see FIG. 5).

The signal blocking portion 49 and the translucent portion 33 may form a space therebetween in the insertion and removal directions 50. This space allows infrared light traveling in the width direction 51 to pass without being attenuated to an amount smaller than a predetermined amount. The shape of the signal blocking portion 49 along the insertion and removal directions 50 may be changed according to the type of the ink cartridge 30. The term the “type of the ink cartridge 30” includes: the difference in color or content of ink, the difference in amount of ink stored initially in the ink chamber 36, and so on. The third detection portion 49 corresponds to the signal blocking portion in the same manner as the translucent portion 33 corresponds to the signal blocking portion.

As depicted in FIG. 3, a guided portion 35 may extend in the depth direction 53 and may be positioned on the upper wall 39 of the cartridge body 31. The guided portion 35 may comprise of a rib or a projecting strip projected upward from the upper wall 39. The distance between a pair of side surfaces of the guided portion 35 opposed in the width direction 51 may be shorter than the distance between a pair of side surfaces of the cartridge body 31 opposed in the width direction 51. In other words, the dimension of the guided portion 35 in the width direction 51 is smaller than the dimension of the cartridge body 31 in the width direction 51.

A guided portion 44 may protrude downward from the bottom wall 41 of the cartridge body 31 and may extend along the depth direction 53. The guided portion 44 may comprise a rib or a projecting segment. Further, the guided portion 44 may have a width smaller than the width of the cartridge body 31. The cartridge mounting portion may comprise a guide groove 109 configured to guide the guided portions 35 and 44 along the guide groove 109 in the insertion and removal directions 50 (see FIG. 5).

As depicted in FIG. 2, the ink supply device 100 may be positioned on the image recording apparatus 10. The ink supply device 100 may be configured to supply ink to the recording head 21 positioned in the image recording apparatus 10. The ink supply device 100 comprises the cartridge mounting portion 110 in which the ink cartridge 30 may be inserted. FIG. 1 depicts a state in which the ink cartridge 30 is inserted into the cartridge mounting portion 110.

As depicted in FIG. 5, a case 101 forming the cartridge mounting portion 110 may comprise the opening 112 formed on the front side of the image recording apparatus 10. The ink cartridge may be inserted into and removed from the case 101 via opening 112. The guide grooves 109 may guide the ink cartridge 30 in the insertion and removal directions 50 when the guided portion 35 is inserted into one of the guide grooves 109. An internal space of the case 101 is defined by: a ceiling surface formed by the upper guide groves 109 and which defines a ceiling portion of an internal space of the case 101, a floor surface formed by the lower guide grooves 109 and which defines a bottom portion of the internal space of the case 101, a terminal end wall 104 opposite to the opening 112 in the insertion and removal directions 50 and which defines a terminal surface of the internal space of the case 101, a pair of side walls 105 and 106 extending in the insertion direction 56 and connecting the top wall 111 to the bottom wall 107. The guide grooves 109 may guide the ink cartridge 30 in the insertion and removal directions 50 when the guided portion 35 is inserted into the guide groove 109 positioned on a ceiling surface and the guided portion 44 is inserted into the guide groove 109 positioned on a floor surface. The case 101 may accommodate a plurality of ink cartridges 30, e.g., four ink cartridges 30. In the embodiment of the invention, each of the four ink cartridges 30 may correspond to ink cartridges storing one of cyan ink, magenta ink, yellow ink, and black ink, respectively.

The case 101 may comprise three plates 102 that divide the internal space of case 101 into four vertically long spaces. Each of the four vertically long spaces may accommodate an ink cartridge 30. The plates 102 may be positioned on the side of the terminal surface of the internal space of the case 101.

As depicted in FIG. 6, a connecting portion 103 may be positioned at a lower portion of the terminal surface of the internal space of the case 101. On the terminal surface, each of the connecting portions 103 may be positioned at a position corresponding to the ink supply units 37 of the ink cartridges 30 inserted into the case 101. In the embodiment, a plurality of connecting portions 103, e.g., four connecting portions 103, may be positioned to correspond to the plurality of ink cartridges 30, e.g., four ink cartridges 30, which case 101 may accomodate.

Each of the connecting portions 103 may comprise the ink needle 122 and a holding portion 121. The ink needle 122 may be formed by a tubular, resin needle. The ink needles 122 may connect to the ink tubes 20 on the side of the external surface of the case 101, which may be formed on the inside and the outside of the case 101 and may pass through the terminal surface of the case 101. The ink tubes 20 may be pulled upward along the external surface of the case 101, and thereafter, the ink tubes 20 may be extended to the recording head 21 of the image recording apparatus 10 to distribute the ink thereto.

The holding portions 121 may have a substantially cylindrical shape. The ink needle 122 may be positioned at a center of the holding portion 121. As depicted in FIG. 6, when the ink cartridge 30 is inserted into the cartridge mounting portion 110, the ink supply unit 37 may be inserted into the inside of the cylinder of the holding portion 121. In this process, the outer circumferential surface of the ink supply unit 37 may contact an inner circumferential surface of the cylinder of the holding portion 121. Thereby, the ink supply unit 37 may insert into the holding portion 121 with a predetermined gap formed therebetween. As the ink supply unit 37 is inserted into the holding portion 121, the ink needle 122 may insert into the ink supply port 71 of the ink supply unit 37. Thereby, ink may flow from the ink chamber 36 into an exterior of the ink chamber, e.g., through the ink needle 122 and into the ink tube 20.

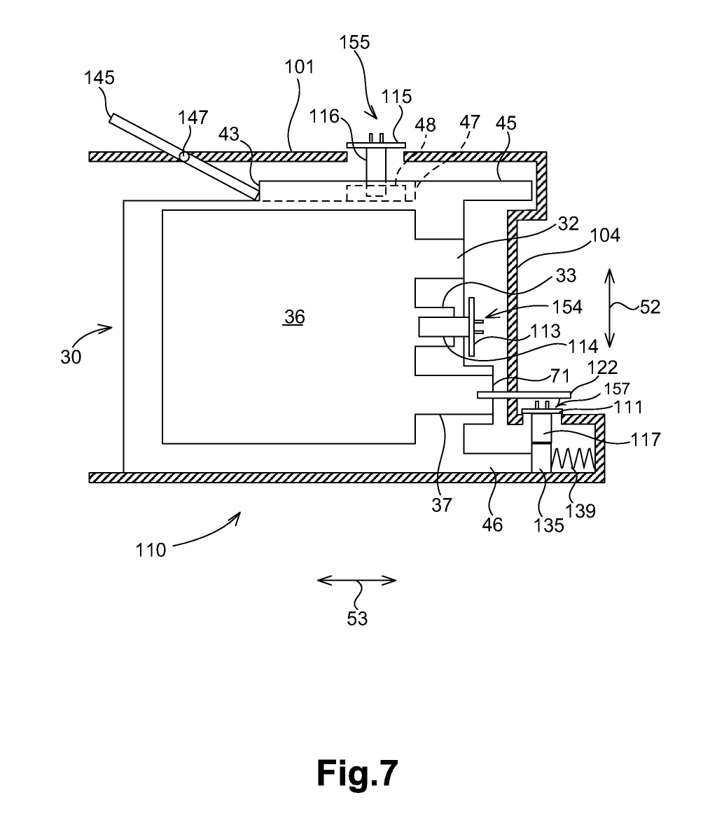

As depicted in FIG. 6 and FIG. 7, a first sensor unit 154 may be positioned at the terminal surface of the internal space of the case 101, above the connecting portion 103 in the gravity direction, i.e., along height direction 52. The first sensor unit 154 may comprise a substrate 113 and the first optical sensor 114. The first sensor unit 154 may be configured with the first optical sensor 114 installed on the substrate 113. The substrate 113 and the first optical sensor 114 may be electrically connected and fixed together by soldering or the like. The first sensor unit 104 may comprise a plurality of first optical sensors 114, e.g., four first optical sensors 114. Four first optical sensors 114 may correspond to four ink cartridges 30, which case 101 may accommodate. Four first optical sensors 114 may be positioned between the plates 102 in a line along the width direction 51 of the case 101.

Each of the first optical sensors 114 may comprise the light-emitting element 118 and the light-receiving element 119. In the present embodiment, the light-emitting element 118 may be an LED or other light source. In another embodiment of the invention, the light receiving element 119 may be a phototransistor or other suitable light collecting or detecting device. The light-emitting element 118 and the light-receiving element 119 may be substantially surrounded by a casing. The first optical sensor 114 may have a substantially horseshoe-like external shape formed by the casing. The light-emitting element 118 may emit light from the casing in one direction. The light-receiving element 119 may receive the light emitted to the casing from one direction. The light-emitting element 118 and the light-receiving element 119 may be positioned in the horseshoe-shaped casing such that light emitting element 118 and light receiving element 119 may face each other at a predetermined gap formed therein. The translucent portion 33 and the signal blocking portion 49 of the ink cartridge 30 may enter the optical path of the first optical sensor 114, and may block, deflect, or absorb the light transmitted from the light-emitting element 118 to the light-receiving element 119. Then, the first optical sensor 114 may detect a change in the amount of transmitted light caused by the translucent portion 33 or the signal blocking portion 49.

As depicted in FIG. 6 and FIG. 7, the first optical sensor 114 and the substrate 113 may be positioned at a terminal surface side of the ceiling surface of the case 101. For example, as depicted in FIG. 6 and FIG. 7, the distal end of the ink needle 122 may be positioned closer to the terminal surface of the cartridge mounting portion 110 than the first optical sensors 114 and substrates 113 in the insertion and removal directions 50, i.e., on the terminal surface side in the insertion direction 56 with respect to an end of the ink needle 122 in the removal direction 55.

The first optical sensor 114 and the substrate 113 may not necessarily be required to be positioned farther away from the terminal surface of the cartridge mounting portion 110 than the distal end of the ink needle 122 in the in insertion and removal directions 50. For example, the first optical sensor 114 and the substrate 113 may only have to be positioned behind a boundary portion 72 in the insertion direction 56 (see FIG. 6) when the ink cartridge 30 is inserted into the cartridge mounting portion 110. In other words, the first optical sensor 114 and the substrate 113 may be positioned farther away from the terminal surface of the cartridge mounting portion 110 in insertion and removal directions 50 than the ink needle 122.

As depicted in FIG. 6 and FIG. 7, the first optical sensor 114 and the substrate 113 may be positioned behind the ink supply portion 71 in the insertion direction 56 when the ink cartridge 30 is inserted into the cartridge mounting portion 110.

The terminal surface of the case 101 may comprise a second sensor unit 157 below the connecting portions 103 in the gravity direction, i.e., height direction 52, and above the slide members 135 in the gravity direction. The second sensor unit 157 includes a substrate 111 and a second optical sensor 117. The second sensor unit 157 may be configured with the second optical sensor 117 installed on the substrate 111. The second sensor unit 157 may comprise plurality of second optical sensors 117, e.g., four second optical sensors 117. These four second optical sensors 117 correspond to the four ink cartridges 30 which can be accommodated in the case 101. In other words, the four second optical sensors 117 correspond to four slide members 135. The four second optical sensors 117 are arranged on the upper side of a chamber 130 in a line along the width direction 51 of the case 101.

As depicted in FIG. 6, the translucent portion 33 and the signal blocking portion 49 may be positioned behind the connecting portion 103 in the insertion direction 56 when the ink cartridge 30 is inserted into the cartridge mounting portion 110. For example, the translucent portion 33 and the signal blocking portion 49 may be positioned behind the distal end of the ink needle 122 in the insertion direction 56 when the ink cartridge 30 is inserted into the cartridge mounting portion 110.

In the case of the translucent portion 33 and the signal blocking portion 49, as well, these components need not be positioned completely behind or directly behind a further rearward component. For example, the translucent portion 33 and the signal blocking portion 49 may be positioned only as far back as the boundary portion 72 (see FIG. 6) between the ink needle 122 and the ink supply port 71 when the ink cartridge 30 is installed into the cartridge mounting portion 110.

As depicted in FIG. 6, the chamber 130 may be positioned at a lower end portion of the terminal surface of the case 101, and a slide member 135 may be movably positioned in the chamber 130. In the present embodiment, a plurality of slide members 135, e.g., four slide members 135, may be positioned to correspond to the plurality of ink cartridges 30, e.g., four ink cartridges 30, accommodated in case 101. The chamber 130 may be continue to the internal space of the cartridge mounting portion 110. The slide members 135 may be supported by a supporting rod 133 extending along the insertion and removal directions 50 in the space 130 so as to be slidable along the insertion and removal directions 50. The slide member 135 may have a substantially parallelepiped outline shape. A plate member 136 may extend along the insertion and removal directions 50 and may be positioned on an upper end of the slide member 135. The slide member 135 may be positioned along an insertion route of the first projection 46, and the slide member 135 may be capable of coming into abutment with the first projection 46.

A coil spring 139 may be positioned in the chamber 130. The coil spring 139 may be configured to biase the slide member 135 toward the opening 112, i.e., for biasing the ink cartridge 30 in the removal direction. The coil spring 139 may be positioned at the supporting rod 133 and may extend along the insertion and removal directions 50 in the chamber 130. The coild spring 139 may be interposed between a terminal wall 131, which defines a terminal surface of the chamber 130, and the slide member 135. When the coil spring 139 has a natural length, i.e., when the slide member 135 is not urged by an external force, the slide member 135 may be positioned at a predetermined position (first position) on the side of the opening 112. In the process of inserting the ink cartridge into the cartridge mounting portion 110, the first projection 46 of the ink cartridge 30 may contact the slide member 135, and the slide member 135 may be pushed against biasing force of the coil spring 139 toward the terminal wall 131 of the chamber 130. Thereby, the coil spring 139 may be compressed, and the slide member 135 may slide to a position (second position, see FIG. 6) on the side of the terminal wall 131 different from the predetermined position. Consequently, the compressed coil spring 139 may bias the ink cartridge 30 in the removal direction 55 via the slide member 135.

As depicted in FIG. 5 and FIG. 6, the case 101 may include the lock lever 145. The lock lever 145 may be configured to retain the ink cartridge 30 inserted into the cartridge mounting portion 110 in a mounted state and being urged by biasing force of the coil spring 139. The lock lever 145 may be positioned at an upper end of the opening 112 of the case 101. In the present embodiment, a plurality of lock levers 145, e.g., four lock levers 145, may be positioned to correspond to the plurality of ink cartridges 30, e.g., four ink cartridges 30, which may be inserted into the case 101.

Each of the lock levers 145 may have a substantially arm shape. The lever portion 145 may have a center portion through which a supporting shaft 147 may extend. The case 101 may support the shaft 147. Thereby, the lock lever 145 may be pivotally movable about the supporting shaft 147 at the upper side of the opening 112 of the case 101. The lock lever 145 may have one side serving as an operating unit 149 and another side serving as an engaging portion 146. The operating unit 149 may be configured to extend outward from the opening 112 to allow a user to manually pivot or move the lock lever 145. The engaging portion 146 may extend into the interior of the case 101. The engaging portion 146 may be configured to engage with the engaged portion 43 of the ink cartridge 30. When the engaging portion 146 engages the engaged portion 43, the ink cartridge 30 biased by the coil spring 139 is maintained in the state of being mounted to the case 101. The lock lever 145 may rotate between a lock position, which corresponds to a position in which the engaging portion 146 is configured to engage with the engaged portion 43, and an unlock position which correponds to a position in which the engaging portion 146 does not engage the engaged portion 43 (see FIG. 6).

A coil spring 148 may be attached to the lock lever 145. The lock lever 145 may be biased toward the lock position by the coil spring 148. When the lock lever 145 is in the lock position and the operating unit 149 is biased downward in the gravity direction, i.e., along height direction 52, the lock lever 145 is rotated from the lock position to the unlock position.

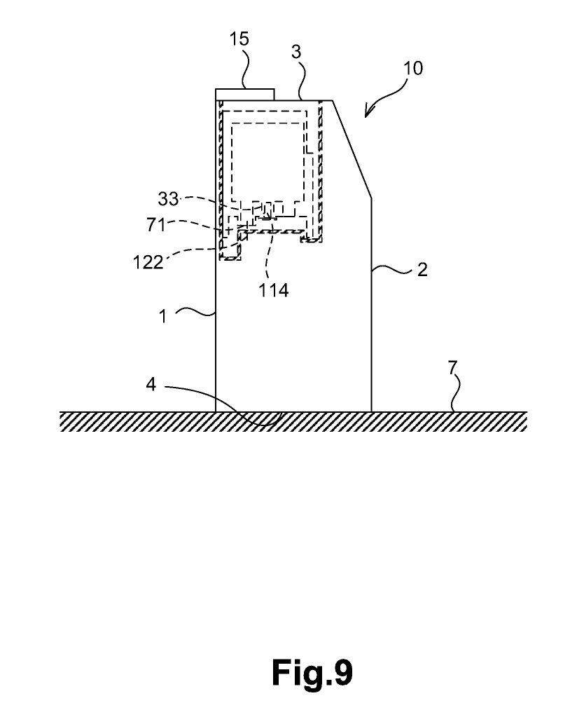

As depicted in FIG. 1, when the image recording apparatus is used, the image recording apparatus 10 may be placed on a placement surface, e.g., desk or floor or the like. In other words, a lower surface 1 of the image recording apparatus 10 may support the image recording apparatus 10 while contacting with the placement surface when the image recording apparatus 10 is placed thereon. In contrast, when the image recording apparatus 10 is not in use, the image recording apparatus may be placed on the rear surface 4 of the image recording apparatus 10 and rear surface 4 may support the image recording apparatus 10 while contacting with the placement surface 7, as depicted in FIG. 9. In other words, the rear surface 4 is positioned lower than the front surface 3. Further, when the rear surface 4 of the image recording apparatus 10 is placed on the placement surface 7, as depicted in FIG. 9, front surface 3 of the image recording apparatus 10 becomes an upper surface of the image recording apparatus 10 in the gravity direction, i.e., now parallel to the depth direction 53. The image recording apparatus 10 may be placed on the desk or floor directly, or may be placed on a stand placed on the desk or floor irrespective of whether the image recording apparatus 10 takes the position depicted in FIG. 1 or the position depicted in FIG. 9.

When the image recording apparatus 10 is placed in the position depicted in FIG. 1, the translucent portion 33 and the signal blocking portion 49 may be positioned behind the ink supply port 71 in the insertion direction 56 as depicted in FIG. 4. The translucent portion 33 and the signal blocking portion 49 may be positioned behind the connecting portion 103 in the insertion direction 56 when the ink cartridge 30 is installed into the cartridge mounting portion 110 as depicted in FIGS. 6 and 7.

Thereby, when the image recording apparatus 10 is installed in the position depicted in FIG. 9, the translucent portion 33 and the signal blocking portion 49 may be positioned above the ink supply port 71 in the insertion direction 56. Also, the translucent portion 33 and the signal blocking portion 49 may be positioned above the connecting portion 103 in the insertion direction 56 when the ink cartridge 30 is inserted into the cartridge mounting portion 110.

When the image recording apparatus 10 is inserted in the position depicted in FIG. 1, the first optical sensor 114 and the substrate 113 may be positioned behind the connecting portion 103 in the insertion direction 56. The first optical sensor 114 and the substrate 113 may be positioned behind the ink supply port 71 in the insertion direction 56 when the ink cartridge 30 is inserted into the cartridge mounting portion 110.

Thereby, when the image recording apparatus 10 is installed in the position depicted in FIG. 9, the first optical sensor 114 and the substrate 113 may be positioned at a level higher than the connecting portion 103 in the insertion direction 56. Also, the first optical sensor 114 and the substrate 113 may be positioned at a level higher than the ink supply port 71 in the insertion direction 56 when the ink cartridge 30 is inserted into the cartridge mounting portion 110.

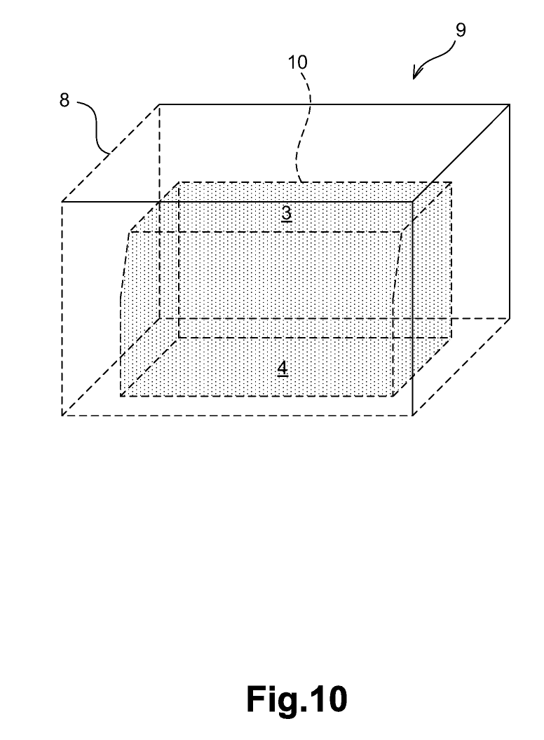

The image recording apparatus 10 may be packaged with a box-shaped material 8 formed of a packing material, such as corrugated cardboard carton, Styrofoam, or the like. The box-shaped material may correspond to a box. In this case, as depicted in FIG. 10, the image recording apparatus 10 may be packaged in the position depicted in FIG. 9. In other words, front surface 3 of the image recording apparatus 10 becomes an upper surface of the image recording apparatus 10 in the gravity direction, i.e., now parallel to the depth direction 53, when the image recording apparatus 10 is packaged within the box-shaped material 8, as depicted in FIG. 9. An image recording apparatus packaged body 9 may comprise the box-shaped material 8 and the image recording apparatus 10 packaged within the box-shaped material 8.

Thereby, when the image recording apparatus 10 is packaged and positioned as depicted in FIG. 9 and as described above, the relative positions of the translucent portion 33, the signal blocking portion 49, the first optical sensor 114, the substrate 113, the ink supply port 71, and the connecting portion 103 may be the same as the relative positions thereof when the image recording apparatus 10 is positioned as depicted in FIG. 1.

According to the present embodiment, the image recording apparatus 10 may take a position in which the front surface 3 and the rear surface 4 extend upright from the bottom surface when in use. In this state, the first optical sensor 114 may be positioned behind the the ink supply port 71 and the connecting portion 103 in the insertion direction 56. The image recording apparatus 10 may be maintained in a position in which the rear surface 4 comes to a position below the front surface 3 in the gravity direction, e.g., when not in use. Then, when the image recording apparatus 10 is maintained in this position, the first optical sensor 114 may come to a position at a higher level than the ink supply port 71 and the connecting portion 103. Thereby, even when ink is leaked from the ink supply port 71 or the connecting portion 103, adhesion of the ink to the first optical sensor 114, breakdown, or erroneous detection of the first optical sensor 114 due to the adhesion may be prevented.

The translucent portion 33 may be positioned farther behind the ink supply port 71 and the connecting portion 103 in the insertion direction 56 when the ink cartridge 30 is inserted in the cartridge mounting portion 110.

When ink is adhered to the translucent portion 33, the first optical sensor 114 may detect the translucent portion 33 erroneously. Nevertheless, in the present embodiment, when the image recording apparatus 10 is maintained in the position in which the rear surface 4 comes to a position below the front surface 3 in the gravity direction, the translucent portion 33 comes to a position above the ink supply port 71 and the connecting portion 103. Thereby, even when ink is leaked from the ink supply port 71 or the connecting portion 103, the ink may not adhere to the translucent portion 33.

Also, the signal blocking portion may comprise the translucent portion 33 which allows inflow of the ink stored in the ink chamber 36 and which may change a light transmission state based on the amount of ink stored in the ink chamber 36.

When the ink adheres to the translucent portion 33, the ink may impair normal discrimination of the change in light transmission state. Nevertheless, in the present embodiment, when the image recording apparatus 10 is maintained in the position in which the rear surface 4 is positioned below the front surface 3 in the gravity direction, the translucent portion 33 may be positioned above the ink supply port 71 and the connecting portion 103. Thereby, even when ink is leaked from the ink supply port 71 or the connecting portion 103, the ink may not adhere to the translucent portion 33.

The cartridge mounting portion 110 may further include the substrate 113 positioned behind the connecting portion 103 in the insertion direction 56 and electrically connected to the first optical sensor 114. The substrate 113 may be positioned behind the ink supply port 71 in the insertion direction 56 when the ink cartridge 30 is inserted in the cartridge mounting portion 110.

When ink is adhered to the substrate 113, the first optical sensor 114 electrically connected to the substrate 113 may be broken down due to an undesired short circuit of wirings on the substrate 113. Nevertheless, in the present embodiment, when the image recording apparatus 10 is positioned with the rear surface 4 below the front surface 3 in the gravity direction, the substrate 113 may be positioned above the ink supply port 71 and the connecting portion 103. Thereby, even when ink leaks from the ink supply port 71 or the connecting portion 103, the ink may not adhere to the substrate 113.

Protrusions (portions of the paper feed tray 15 and the paper discharge tray 16 projecting from the image recording apparatus 10 in a state of being inserted in the image recording apparatus 10) projecting toward the opposite side from the rear surface 4 may be positioned on the front surface 3.

Because the first and second protrusions are positioned on the front surface 3, if the image recording apparatus 10 is positioned with front surface 3 as the bottom surface, it may be difficult to stabilize the position of image recording apparatus 10. Therefore, the image recording apparatus 10 may be positioned more stably by positioning the rear surface 4 as the bottom surface rather than positioning the front surface 3 as the bottom surface. Thereby, the image recording apparatus 10 comprising the first and second protrusions allows users to enjoy merits of the relative positions of the translucent portion 33, the signal blocking portion 49, the first optical sensor 114, the substrate 113, the ink supply port 71, and the connecting portion 103 as described in the present embodiment. In other words, even when the ink leaks from the ink supply port 71 or the connecting portion 103 when the image recording apparatus 10 is positioned with the rear surface 4 contacting the placement surface, adhesion of the ink to the translucent portion 33, the signal blocking portion 49, the first optical sensor 114, and the substrate 113; the resulting breakdown of the first optical sensor 114 and the substrate 113; or erroneous detection due to the adhesion may be prevented.

By packaging the image recording apparatus 10 with the rear surface 4 positioned below the front surface 3 in the gravity direction, enhanced portability may be achieved and the risk of breakdown may be reduced. By packaging the image recording apparatus 10 with the rear surface 4 positioned below the front surface 3 in the gravity direction, the first optical sensor 114, the substrate 113, the translucent portion 33, and the signal blocking portion 49 may be positioned above the ink supply port 71 and the connecting portion 103. In other words, adhesion of ink on the first optical sensor 114, the substrate 113, the translucent portion 33, and the signal blocking portion 49 due to the leakage of the ink from the ink supply port 71 or the connecting portion 103 may be prevented. The packaging portion may also comprise a cushioning packaging, e.g., styrofoam packaging or paper packaging, which serves as a buffer of the image recording apparatus.

### Modification 1

In the embodiment described above, the translucent portion 33 and the signal blocking portion 49 may correspond to the detected portion, and the first optical sensor 114 and the substrate 113 may correspond to the first sensor unit. Nevertheless, the translucent portion and the first sensor unit are not limited thereto.

For example, as described below in detail, an additional optical sensor 116 may be positioned on the cartridge mounting portion 110 and configured to detect whether or not the ink cartridge 30 is inserted into the cartridge mounting portion 110. The substrate 115 may electrically connect to the additional optical sensor 116. Also, a rib 48 may be positioned on the ink cartridge 30 and detected by the additional optical sensor 116.

As illustrated in broken line in FIG. 7, a groove 47 may extend in the depth direction 53 and may be formed at the center in the width direction 51 of the guided portion 35. The groove 47 may open upward in the height direction 52 in the second projection 45. The cross-sectional shape along the height direction 52 of the groove 47 may be a concave shape.

In an internal space of the groove 47, the rib 48 extending in the height direction 52 and the depth direction 53 may be positioned at the center in the width direction 51 of a bottom surface of the groove 47. The rib 48 may extend upright from the bottom surface of the groove 47. Both side surfaces of the rib 48 in the width direction 51 may oppose a pair of side surfaces of the groove 47 which oppose in the width direction 51 respectively and are parallel to each other. The rib 48 may block or attenuate light traveling in the width direction 51 and may be sensed by the additional optical sensor 116.

In the ink cartridge 30, the rib 48 may be arranged behind the ink supply unit 37 in the insertion direction 56. In addition, the rib 48 may be arranged behind the connecting portion 103 in the insertion direction 56 when the ink cartridge 30 is inserted in the cartridge mounting portion 110. For example, in Modification 1, the rib 48 may be arranged rearward of the distal end of the ink needle 122 in the insertion direction 56 when the ink cartridge 30 is inserted in the cartridge mounting portion 110.

In the case of the rib 48 as well, it may not be necessary to mount the rib 48 on the front side of the distal end of the ink needle 122 in the insertion direction 56 in the same manner as the first optical sensor 114, the substrate 113, the translucent portion 33, and the signal blocking portion 49 in the embodiment described above. For example, the rib 48 may be arranged rearward of the boundary portion 72 (see FIG. 6) between the ink needle 122 and the ink supply port 71 in the insertion direction 56 when the ink cartridge 30 is inserted in the cartridge mounting portion 110.

As depicted in FIGS. 6 and 7, an additional sensor unit 155 may be positioned on a upper surface of the case 101. The additional sensor unit 155 may comprise the substrate 115 with the additional optical sensor 116 mounted thereon. The additional sensor unit 155 may comprise a plurality of the additional optical sensors 116, e.g., four of the additional optical sensors 116. For example, four additional optical sensors 116 may correspond to four ink cartridges 30, which can be stored in the case 101. The plurality of additional optical sensors 116 may be arranged in a row in the width direction of the case 101 (which corresponds to the width direction 51) between the respective plates 102.

When the ink cartridge 30 is inserted into the case 101, the first detection portion, e.g., plate member 48, of the second projection 45 enters the optical path of the additional optical sensor 116. The image recording apparatus 10 may determine the installation state of the ink cartridge 30 when the additional optical sensor 116 detects a signal change. The additional optical sensor 116 has a light-emitting element and a light-receiving element in the same manner as the first optical sensor 114 (a description of the detailed configuration of the additional optical sensor 116 is omitted here).

In the cartridge mounting portion 110, the additional optical sensor 116 and the substrate 115 may be arranged rearward of the connecting portion 103 in the insertion direction 56. For example, in Modification 1, the additional optical sensor 116 and the substrate 115 may be arranged rearward of the distal end of the ink needle 122 in the insertion direction 56.

The additional optical sensor 116 and the substrate 115 may not necessarily be required to be arranged forward of the distal end of the ink needle 122 in the insertion direction 56 in the same manner as the cases of the first optical sensor 114, the substrate 113, the translucent portion 33, and the signal blocking portion 49 in the embodiment described above. For example, the additional optical sensor 116 and the substrate 115 may be arranged rearward of the boundary portion 72 (see FIG. 6) between the ink needle 122 and the ink supply port 71 in the insertion direction 56 when the ink cartridge 30 is inserted into the cartridge mounting portion 110.

The additional optical sensor 116 and the substrate 115 may be positioned rearward of the ink supply port 71 in the insertion direction 56 when the ink cartridge 30 is inserted into the cartridge mounting portion 110.

In the description given above, a configuration in which the additional optical sensor 116 and the substrate 115 may be positioned at ceiling surface of the case 101 is described. Nevertheless, the additional optical sensor 116 and the substrate 115 may be positioned at a bottom surface of the case 101. Because the configurations of the additional optical sensor 116 and the substrate 115 are the same as those described above, further description of the configuration of the additional optical sensor 116 and the substrate 115 is omitted here.

Even when the additional optical sensor 116 and the substrate 115 is positioned at the floor surface of the case 101, the additional optical sensor 116 and the substrate 115 may be arranged rearward of the connecting portion 103 in the insertion direction 56 similarly to the configuration in which they may be positioned at the ceiling surface of the case 101. Even when the additional optical sensor 116 and the substrate 115 are positioned at the floor surface of the case 101, the additional optical sensor 116 and the substrate 115 may be positioned rearward of the ink supply port 71 in the insertion direction 56 where the ink cartridge 30 is inserted in the cartridge mounting portion 110.

The additional optical sensor 116 and the substrate 115 may be positioned at both the ceiling surface and the floor surface of the case 101. In this configuration, the additional optical sensor 116 and the substrates 115 may be positioned at one or more of rearward of the connecting portion 103 in the insertion direction 56 and rearward of the ink supply port 71 in the insertion direction 56 where the ink cartridge 30 is inserted into the cartridge mounting portion 110.

### Modification 2

The front surface 3 may be curved toward the opposite side from the rear surface 4. FIG. 8B depicts an example of the image recording apparatus 10 in which the front surface 3 is curved.

The image recording apparatus 10 may have a curved shape on the front surface 3 to improve an impression in appearance. Then, if the front surface 3 is curved in the direction opposite from the rear surface 4, the image recording apparatus 10 may not be positioned stably when the front surface 3 used as the bottom surface. Therefore, the image recording apparatus 10 may be positioned stably using the rear surface 4 as the bottom surface rather than using the front surface 3 as the bottom surface as depicted in FIG. 9.

Accordingly, the image recording apparatus 10 having the curved front surface 3 allows the user to benefit from the relative positions of the translucent portion 33, the signal blocking portion 49, the first optical sensors 114, the additional optical sensors 116, the substrates 113 and 115, the ink supply port 71, and the connecting portion 103 similarly to the first embodiment described above. In other words, even when ink leaks from the ink supply port 71 or the connecting portion 103 when the image recording apparatus 10 is positioned using the rear surface 4 as the bottom surface, adhesion of the ink to the translucent portion 33, the signal blocking portion 49, the first optical sensors 114, the additional optical sensors 116, and the substrates 113 and 115; failure of the first optical sensors 114, the additional optical sensors 116, and the substrates 113 and 115; or erroneous detection due to the adhesion may be prevented.

While the invention has been described in connection with various example structures and illustrative embodiments, it will be understood by those skilled in the art that other variations and modifications of the structures and embodiments described above may be made without departing from the scope of the invention. Other structures and embodiments will be apparent to those skilled in the art from a consideration of the specification or practice of the invention disclosed herein. It is intended that the specification and the described examples are illustrative with the true scope of the invention being defined by the following claims.

What is claimed is:

1. A print liquid cartridge, comprising:
a liquid chamber configured to accumulate print liquid therein, wherein the liquid chamber is positioned between a front side of the print liquid cartridge and a rear side of the print liquid cartridge positioned opposite to the front side;
a liquid supply portion configured to supply print liquid accumulated in the liquid chamber to an exterior of the liquid chamber, wherein the liquid supply portion is positioned at the front side of the print liquid cartridge;
a translucent portion configured to be in fluid communication with an interior of the liquid chamber and configured to change a light-transmitting state when an amount of the liquid accumulated in the liquid chamber changes, wherein the translucent portion is positioned at the front side of the print liquid cartridge,
wherein the liquid supply portion projects farther than the translucent portion from the rear side of the print liquid cartridge.

2. The print liquid cartridge according to claim 1, further comprising:
a first projecting portion positioned at a lower end portion of the front side of the print liquid cartridge;
a second projecting portion positioned at an upper end portion of the front side of the print liquid cartridge,
wherein the first projecting portion and the second projecting portion are positioned farther forward than the liquid supply portion along the insertion direction.

3. The print liquid cartridge according to claim 2, further comprising:
a signal blocking portion configured to attenuate or block a transmission of light,
wherein the signal blocking portion is positioned farther forward than the translucent portion from the rear side of the print liquid cartridge.

4. The print liquid cartridge according to claim 3,
wherein the first projecting portion projects farther than the liquid supply portion from the rear side of the print liquid cartridge and comprises a first detection portion configured to be detected by a first detector, and
wherein the second projecting portion projects farther than the liquid supply portion from the rear side of the print liquid cartridge and comprises a second detection portion configured to be detected by a second detector.

5. An image recording apparatus, comprising:
a cartridge mounting portion configured to mount therein a print liquid cartridge when the print liquid cartridge is inserted into the cartridge mounting portion in an insertion direction,
wherein the print liquid cartridge comprises:
a liquid chamber configured to accumulate print liquid therein;
a liquid supply portion configured to supply print liquid accumulated in the liquid chamber to an exterior of the liquid chamber;
a translucent portion configured to be in fluid communication with an interior of the liquid chamber and configured to change a light-transmitting state when an amount of the liquid accumulated in the liquid chamber changes;
a first projecting portion positioned at a lower end portion of a front side of the print liquid cartridge and comprising a first detection portion;
a second projecting portion positioned at an upper end portion of the front side of the print liquid cartridge and comprising a second detection portion; and
a signal blocking portion configured to attenuate or block a transmission of light, and
wherein the cartridge mounting portion comprises:
a liquid supply needle extending along the insertion direction and configured to insert into the liquid supply portion;
a first sensor unit configured to output first detection information based on a detection of the first detection portion;
a second sensor unit which outputs second detection information based on a detection of the second detection portion;
a third sensor unit configured to output third detection information based on a detection of the signal blocking portion and a detection of the light-transmitting state of the translucent portion.

6. The image recording apparatus according to claim 5,
wherein the cartridge mounting portion further comprises:
a biasing member configured to bias the print liquid cartridge in a direction opposite to the insertion direction, and
a locking member configured to have a position which shifts from a first position to a second position,
wherein the locking member is configured to retain the print liquid cartridge against a biasing force applied by the biasing member in a mounted state when the locking member is in the first position, and
wherein the locking member is configured to allow the print liquid cartridge to move in the direction to the biasing force when the locking member is in the second position.

7. The image recording apparatus according to claim 6,
wherein the cartridge mounting portion further comprises:
a case comprising:
an opening positioned at front side of the image recording apparatus and;
a terminal surface positioned opposite to the opening along the insertion direction;
an accommodating portion configured to accommodate the print liquid cartridge therein; and
a fourth sensor unit positioned at an upper portion of the terminal surface of the case,
wherein the opening is configured to allow the print liquid cartridge to be inserted into and removed from the accommodating portion through the opening,
wherein the liquid supply needle is positioned at a lower portion of the terminal surface of the case,
wherein the third sensor unit is positioned between the fourth sensor unit and the second sensor unit along a direction perpendicular to the insertion direction, and
wherein a tip end of the liquid supply needle is positioned at an offset from the third sensor unit.

8. The image recording apparatus according to claim 7,
wherein the tip end of the liquid supply needle is positioned farther forward than the third sensor unit in the insertion direction.

9. The image recording apparatus according to claim 8,
wherein the case further comprises:
the second sensor unit which is positioned at a lower position of the terminal surface of the case,
wherein the tip end of the liquid supply needle is positioned at an offset from the second sensor unit in the insertion direction.

10. The image recording apparatus according to claim 9,
wherein the tip end of the liquid supply needle is positioned farther forward than the second sensor unit in a direction opposite to the insertion direction.

11. The image recording apparatus according to claim 7,
wherein the tip end of the liquid supply needle is positioned farther forward than the fourth sensor unit in a direction opposite to the insertion direction.

12. A packaged image recording apparatus, comprising:
a package portion configured to contain an image recording apparatus,
wherein the image recording apparatus comprises:
a cartridge mounting portion configured to mount therein a print liquid cartridge when the print liquid cartridge is inserted into the cartridge mounting portion in an insertion direction,
wherein the cartridge mounting portion comprises:
a liquid supply needle extending along the insertion direction and configured to insert into the liquid supply portion;
a first sensor unit configured to output first detection information based on a detection of the first detection portion;
a second sensor unit which outputs second detection information based on a detection of the second detection portion;
a third sensor unit configured to output third detection information based on a detection of the signal blocking portion and a detection of the light-transmitting state of the translucent portion,
wherein the package portion comprises an opening configured to allow the image recording apparatus to be inserted into the package portion such that a front surface of the image recording apparatus is positioned farther upward in a gravity direction than the rear surface of the image recording apparatus, and
wherein the rear surface of the image recording apparatus is a terminal surface along the insertion direction.

13. The packaged image recording apparatus according to claim 12,
wherein the package portion further comprises a shock absorbing material configured to protect the image recording apparatus to be inserted into the package portion.

14. The image recording apparatus according to claim 5,
wherein at least a portion of the front surface of the image recording apparatus is curved.
